(19) United States
(12) Patent Application Publication
(10) Pub. No.: US 2022/0274603 A1
(43) Pub. Date: Sep. 1, 2022

(54) Method of Modeling Human Driving Behavior to Train Neural Network Based Motion Controllers

(71) Applicants: Continental Automotive Systems, Inc., Auburn Hills, MI (US); Steering Solutions IP Holding Corporation, Auburn Hills, MI (US)

(72) Inventor: Omkar Karve, Farmington Hills, MI (US)

(21) Appl. No.: 17/188,251

(22) Filed: Mar. 1, 2021

(51) Int. Cl. B60W 40/09; B60W 40/072; G06N 3/08; G06N 3/04; G05B 13/02

(52) U.S. Cl. CPC B60W 40/09; B60W 40/072; G06N 3/08; G06N 3/0472; G05B 13/027; B60W 2520/14; B60W 2520/10; B60W 2540/18

(57) ABSTRACT

A number of variations may include a method of training a neural network vehicle motion controller that more closely replicates how a human would drive a vehicle using seat of pants vehicle dynamics variables and look ahead parameters in order to determine how a motion controller should direct the steering angle, throttle and break inputs to the vehicle to navigate the vehicle.

### TECHNICAL FIELD

The field to which the disclosure generally relates to includes vehicle motion controllers and methods of making and using the same including a method of modeling human driving behavior to train neural network based vehicle motion controllers.

### BACKGROUND

Autonomous and semi-autonomous vehicles may use motion controllers to control longitudinal and lateral movement of the vehicle.

### SUMMARY OF ILLUSTRATIVE VARIATIONS

A number of variations may include vehicle motion controllers and methods of making and using the same including a method of modeling human driving behavior to train neural network based vehicle motion controllers.

A number of variations may include a method of training a neural network vehicle motion controller that more closely replicates how a human would drive a vehicle using seat of pants vehicle dynamics variables and look ahead parameters in order to determine how a motion controller should direct the steering angle, throttle and break inputs to the vehicle to navigate the vehicle.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a method of training a neural network to model human driving behavior, which may include characterizing the vehicle's current state, what the driver is looking at in terms of the path geometry and the perceived errors that the driver corrects by applying steering and throttle/brake input.

FIG. 2 is a block diagram of an implementation of the trained neural network which includes trained parameters based on the neural network architecture, wherein X1 is a vector of training inputs shown in FIG. 1 and Y1 is a vector of control parameters which are sent to actuators to control the lateral and longitudinal motion of the vehicle.

FIG. 3 is block diagram illustrating a method of training a neural network.

### DETAILED DESCRIPTION OF ILLUSTRATIVE VARIATIONS

The following description of the variations is merely illustrative in nature and is in no way intended to limit the scope of the invention, its application, or uses.

A number of variations may include vehicle motion controllers and methods of making and using the same including a method of modeling human driving behavior to train neural network based vehicle motion controllers.

A number of variations may include a method of training a neural network vehicle motion controller that more closely replicates how a human would drive a vehicle using “seat of pants” feeling characterized by vehicle dynamics variables and look ahead parameters in order to determine how a motion controller should direct the steering angle, throttle and break inputs to the vehicle to navigate the vehicle.

Heretofore, the lateral and longitudinal vehicle motion controllers have been separate and only infer each other's influences on vehicle dynamics when providing control inputs to vehicle actuators. Those types of methods of motion control lend themselves to very robotic or unnatural vehicle behavior that feels distinctly unfamiliar and uncomfortable to a human vehicle driver and/or occupant.

In a number of variations, look ahead data may be either used as is or be parameterized to a set of equations represented by multi-order differential equations. Later, this data may be fed to a neural network in the input-output format previously prepared to obtain a network with weights and biases that will fit the input data set as closely as possible. These weights and biases may then be deployed as a “homogeneous motion controller” to achieve lateral and longitudinal vehicle motion control in an autonomous or semi-autonomous mode. The same may be accomplished with respect to braking. Weights and biases may be deployed as a “homogeneous motion controller” to achieve vehicle deceleration motion control in an autonomous or semi-autonomous mode. The inputs to such a vehicle motion controller will be exactly the same as what were used in training in terms of the variables. But due to the nature of the generalize nature of the neural network, it will be robotic to variations as compared to training data and will be able to drive on the desired road ahead at a desired speed required by a path planner. As the neural network has been trained on the same vector of inputs, based on the learned behavior modelled in the weights, biases and related process uncertainties, the output of the controller will very closely match what a human would have done if the same set of inputs were to present themselves. This will allow the vehicle to traverse the path in a human like manner even though the controller is not human per say.

In a number of variations, a homogeneous motion controller may provide lateral and longitudinal motion control signals that mimic human driving behavior. In a number of variations, the homogeneous motion controller may be constructed and arranged to provide personalities and varying driving behavior traits by training the neural networks with human vehicle drivers having different driving personalities or characteristics. In a number of variations, the homogeneous motion controller may have the ability continually learn the drivers behavior and adapt to the same using weights and biases and update the neural network occasionally. The neural network may be trained by driving the vehicle in a variety of different personalities or characteristics such as a first driving characteristic which is aggressive wearing the driver turns in a fast or sharp manner, and accelerates and/or decelerates in aggressive or fast manner; An A second driving characteristic which is more moderate than the first driving characteristic and wherein the driver turns in a moderate or less sharply manner, and accelerates and or decelerates in a moderate or less fast manner than the first driving characteristic; in a third driving characteristic which is more conservative than the second driving characteristic and wherein the driver turns more slowly and less sharp, and accelerates and decelerates in a slower or conservative manner than the second driving characteristic. The trained neural network will be constrained downstream to remain within safe operating limits of the vehicle and environment regardless of the learned behavior.

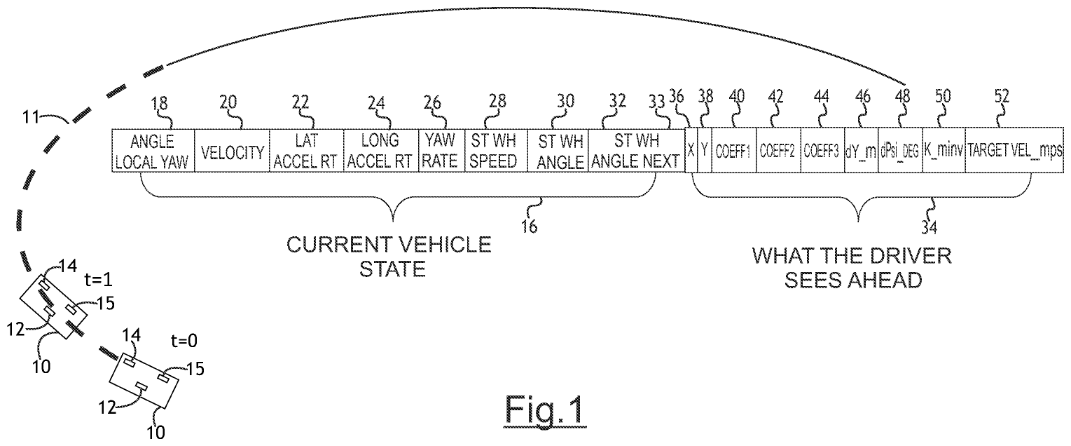

Referring to FIG. 1, a vehicle 10 which may include a plurality of sensors 12, 14 and one or more modules or computing devices 15 may be utilized to determine the current state of a vehicle with respect to a variety of variables including at least one of yaw 18, velocity 20, lateral acceleration 22, longitudinal acceleration 24, yaw rate 26, steering wheel speed 28, steering wheel angle 30, or steering angle target 32. The current status of a vehicle with respect to these parameters maybe recorded at a variety of times such as t=0 and t=1 as the vehicle 10 moves along a path 11. The neural network may also record what the driver sees ahead 34 with respect to a variety of variables including at least one of the X direction 36, the Y direction 38, coefficient #1 40, coefficient #2 42, coefficient #3 44, wherein coefficients #1, #2, and #3 represent the characteristic or parametric curve equation, lateral deviation of the vehicle from intended path 46, heading deviation of vehicles current heading from intended path 48, curvature of the future trajectory 50, or target velocity 52. One or more of these variables may be derived by the one or more modules or computing devices 15. To the current vehicle state 16, other parameters may be added such as environmental conditions, road surface friction and vehicle health information.

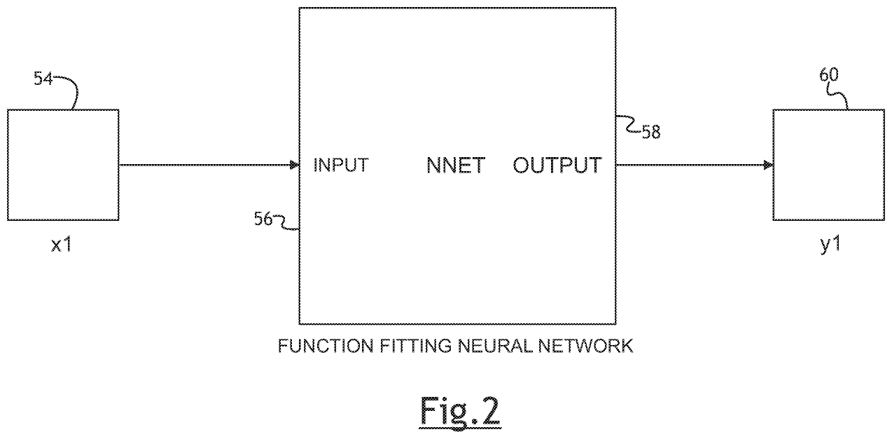

Referring now to FIG. 2, the input data may be delivered to a neural network wherein such input data is from the current state of the vehicle 16 and what the driver sees ahead 34, and other parameters as needed such as whether the output is needed for the first driving characteristic which is aggressive, the second driving characteristic which is moderate, or the third driving characteristic which is conservative. The neural network would be a separate controller and can either work independently or in conjunction with existing traditional control functions and the outputs of each maybe compared or averaged.

A number of variations may include a method of training a neural network including having a human driver drive a test track at a first speed for a first driving characteristic and using a plurality of sensors 12, 14 and one or more modules or computing devices 15 determining the current state of the vehicle at various points of time using at least one of yaw 18, velocity 20, lateral acceleration 22, longitudinal acceleration 24, yaw rate 2,6 speed 28, steering wheel angle 30, or steering angle target 32, and determining what the drive sees ahead at least one of the X direction 36, the Y direction 38, coefficient #1 40, coefficient #2 42, coefficient #3 44, wherein coefficients #1, #2, and #3 represent the characteristic or parametric curve equation, lateral deviation of the vehicle from intended path 46, heading deviation of vehicles current heading from intended path 48, curvature of the future trajectory 50, or target velocity 52 and producing input data from the determining, and communicating the input data to a neural network to model human driving behavior and producing output data therefrom, and communicating the output data to an autonomous driving vehicle modules constructed and arranged to drive a vehicle without human input for at least a period of time. The first speed may be at a relatively fast rate to model human driving behavior of an aggressive driver. The same process may be repeated at a second speed less than the first speed to model the human driving behavior of a moderate driver. Similarly, the same process may be repeated for a third speed less than the second speed to model the human driving behavior of a conservative driver.

A number of variations may include a trained neural network constructed and arranged to produce output data the neural network having been trained by receiving input data derived by having a human driver drive a test track at a first speed for a first driving characteristic and using a plurality of sensors 12, 14 and one or more modules or computing devices 15 determining the current state of the vehicle at various points of time using at least one of yaw 18, velocity 20, lateral acceleration 22, longitudinal acceleration 24, yaw rate 2,6 speed 28, steering wheel angle 30, or steering angle target 32, and determining what the drive sees ahead at least one of the X direction 36, the Y direction 38, coefficient #1 40, coefficient #2 42, coefficient #3 44, wherein coefficients #1, #2, and #3 represent the characteristic or parametric curve equation, lateral deviation of the vehicle from intended path 46, heading deviation of vehicles current heading from intended path 48, curvature of the future trajectory 50, or target velocity 52.

In addition to the training method described above, once the vehicle has been delivered to the customer with a base trained neural network, a software module can be enacted such that the it continuously records vehicle state, lookahead information and driver input in cases where the driver is manually operating the vehicle. If it is determined that the recorded information is from a region of driving characteristic that has been deemed to have a lower confidence in the trained neural network, the information will be fed back to the neural network as additional information and the weights, biases and uncertainties will be updated. This process will ensure continuous learning and improvement of the neural network homogenous controller.

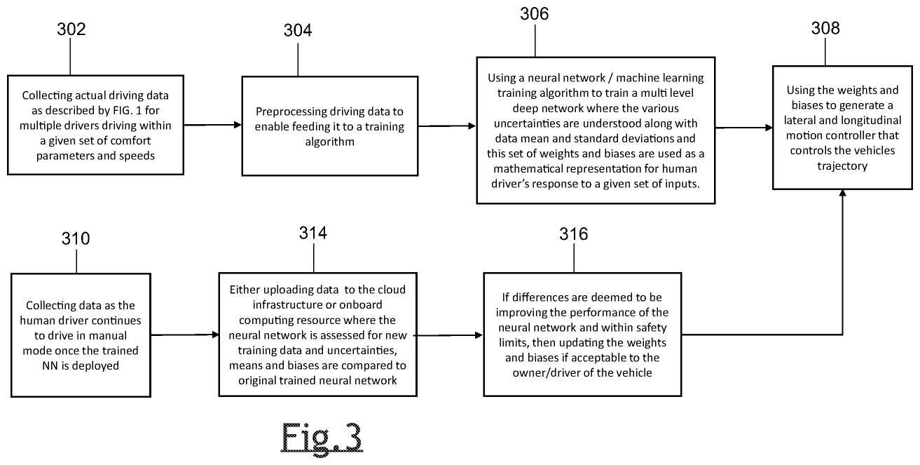

Referring now to FIG. 3, a number of variations may include a method of training a neural network including an initial neural network training and development acts including collecting actual driving data as described by FIG. 1 for multiple drivers driving within a given set of comfort parameters and speeds 302; preprocessing driving data to enable feeding it to a training algorithm 304; using a neural network/machine learning training algorithm to train a multi level deep network where the various uncertainties are understood along with data mean and standard deviations and this set of weights and biases are used as a mathematical representation for human driver's response to a given set of inputs 306; using the weights and biases to generate a lateral and longitudinal motion controller that controls the vehicles trajectory 308; and thereafter performing ongoing or subsequent neural network training and development acts including collecting data as the human driver continues to drive in manual mode once the trained neural network is deployed 310; either uploading data to the cloud infrastructure or onboard computing resource where the neural network is assessed for new training data and uncertainties, means and biases are compared to original trained neural network 312; and if differences are deemed to be improving the performance of the neural network and within safety limits, then updating the weights and biases if acceptable to the owner/driver of the vehicle 314.

The above description of select variations within the scope of the invention is merely illustrative in nature and, thus, variations or variants thereof are not to be regarded as a departure from the spirit and scope of the invention.

What is claimed is:

1. A method of training a neural network including having a human driver drive a test track at a first speed for a first driving characteristic and using a plurality of sensors and one or more modules or computing devices determining the current state of the vehicle at various points of time using at least one of yaw, velocity, lateral acceleration, longitudinal acceleration, yaw rate, speed, steering wheel angle, or steering angle target;
and determining what the drive sees ahead at least one of the X direction, the Y direction, coefficient #1, coefficient #2, coefficient #3, wherein coefficients #1, #2, and #3 represent the characteristic or parametric curve equation, lateral deviation of the vehicle from intended path 46, heading deviation of vehicles current heading from intended path 48, curvature of the future trajectory, or target velocity, and producing input data from the determining, and communicating the input data to a neural network to model human driving behavior and producing output data from the neural network, and communicating the output data to an autonomous driving vehicle modules constructed and arranged to drive a vehicle without human input for at least a period of time.

2. A method as set forth in claim 1, further comprising having a human driver drive a test track at a first speed for a first driving characteristic and using a plurality of sensors and one or more modules or computing devices determining the current state of the vehicle at various points of time using at least one of yaw, velocity, lateral acceleration, longitudinal acceleration, yaw rate, speed, steering wheel angle, or steering angle target;
and determining what the drive sees ahead at least one of the X direction, the Y direction, coefficient #1, coefficient #2, coefficient #3, wherein coefficients #1,#2, and #3 represent the characteristic or parametric curve equation, lateral deviation of the vehicle from intended path 46, heading deviation of vehicles current heading from intended path, curvature of the future trajectory, or target velocity, and producing input data from the determining, and communicating the input data to a neural network to model human driving behavior and producing output data from the neural network, and communicating the output data to an autonomous driving vehicle modules constructed and arranged to drive a vehicle without human input for at least a period of time, and wherein the second speed is less than the first speed.

3. A method as set forth in claim 2, further comprising a method as set forth in claim 1, further comprising having a human driver drive a test track at a first speed for a first driving characteristic and using a plurality of sensors and one or more modules or computing devices determining the current state of the vehicle at various points of time using at least one of yaw, velocity, lateral acceleration, longitudinal acceleration, yaw rate, speed, steering wheel angle, or steering angle target;
and determining what the drive sees ahead at least one of the X direction, the Y direction, coefficient #1, coefficient #2, coefficient #3, wherein coefficients #1, #2, and #3 represent the characteristic or parametric curve equation, lateral deviation of the vehicle from intended path 46, heading deviation of vehicles current heading from intended path 48, curvature of the future trajectory, or target velocity, and producing input data from the determining, and communicating the input data to a neural network to model human driving behavior and producing output data from the neural network, and communicating the output data to an autonomous driving vehicle modules constructed and arranged to drive a vehicle without human input for at least a period of time, and wherein the third speed is less than the second speed.

4. A trained neural network constructed and arranged to produce output data. The neural network having been trained by receiving input data derived by having a human driver drive a test track at a first speed for a first driving characteristic and using a plurality of sensors, and one or more modules or computing devices, determining the current state of the vehicle at various points of time using at least one of yaw, velocity, lateral acceleration, longitudinal acceleration, yaw rate, speed, steering wheel angle, or steering angle target, and determining what the drive sees ahead at least one of the X direction, the Y direction, coefficient #1, coefficient #2, coefficient #3, wherein coefficients #1, #2, and #3 represent the characteristic or parametric curve equation, lateral deviation of the vehicle from intended path 46, heading deviation of vehicles current heading from intended path 48, curvature of the future trajectory, or target velocity, and producing input data from the determining, and communicating the input data to a neural network to model human driving behavior.

5. A method comprising training a neural network having a predetermined neural network model architecture, the method comprising determining the inherent uncertainties within a set of training data and uncertainties within the pre-determined neural network model architecture, before feeding the set of training data causing the data pre-processing to determine homoscedastic and heteroscedastic uncertainties and using them as inputs to allow the neural network to understand and learn how the inputs are spread in the driving space and learn/adjust the mean and standard deviations associated with each network neuron of the neural network weights and biases.
